(19) United States
(12) Patent Application Publication
(10) Pub. No.: US 2023/0011891 A1
(43) Pub. Date: Jan. 12, 2023

(54) Elastic hollow breathable massaging burden-reducing backpack

(71) Applicant: Yingjuan WAN, Guangzhou (CN)

(72) Inventor: Yingjuan WAN, Guangzhou (CN)

(21) Appl. No.: 17/372,562

(22) Filed: Jul. 12, 2021

(51) Int. Cl. A45F 3/12; A45F 3/04; A61H 7/00

(52) U.S. Cl. CPC A45F 3/12; A45F 3/04; A61H 7/001; A45F 2003/003

(57) ABSTRACT

Disclosed is an elastic hollow breathable massaging burden-reducing backpack. Two flexible straps are arranged on the front surface of the backpack in a bilateral symmetry manner, the upper end of each strap is connected to the upper part of the front surface of the backpack through an elastic rope, and the lower end of each strap is fixed by a strap buckle. Each strap is provided with an elastic auxiliary strap, two ends of which are fixed on the corresponding strap. Massage pads are arranged on the inner sides, in contact with human shoulders, of the straps, and a groove, corresponding to the human spine, is formed in the front surface of the backpack.

### BACKGROUND OF THE INVENTION

The present disclosure generally relates to a knapsack, in particular to a backpack.

The structure of an existing backpack is as follows: two inelastic flexible straps are symmetrically arranged on the front surface of the backpack in a bilateral, symmetrical manner. The upper end of each strap is directly connected to the upper part of the front surface of the backpack, and the lower end of each strap penetrates through a strap buckle arranged at the lower part of the front surface of the backpack and then is fixed.

The backpack has the following disadvantages that: 1. when a person walks with a load in the backpack, the backpack can jump up and down along with a walking rhythm, and large falling impact force can be generated when the backpack falls down; 2. the shoulder straps may rub back and forth on human shoulders, and the shoulders may become red and swollen over time; 3. the backpack clings to the human back, and the upper part, the lower part, the front part and the rear part of the backpack press, rub and hit the spine; and 4. in summer, heat cannot dissipate from the human back.

### BRIEF SUMMARY OF THE INVENTION

Provided is an elastic hollow breathable massaging burden-reducing backpack which is capable of effectively slowing down falling impact force, reducing friction on human shoulders, avoiding the spine from being pressed, rubbed and hit and ensuring that heat can better dissipate from human back.

The technical solution which may be employed is as follows:

Provided is an elastic hollow breathable massaging burden-reducing backpack, characterized in that two flexible straps are arranged on the front surface (referring to the surface facing the human body when the person carries the backpack) of the backpack in a bilateral symmetrical manner, the upper end of each strap is connected to the upper part of the front surface of the backpack through an elastic rope (a rubber band), and the lower end of each strap can penetrate through a strap buckle arranged at the lower part of the front surface of the backpack and then is fixed (the lower end of each strap is fixed to the corresponding strap buckle).

On the basis of the above, the following various improvements may further be made:

each strap is provided with an auxiliary elastic strap, two ends of which are fixed on the corresponding strap at a certain interval. Each auxiliary elastic strap is shorter than the strap between the two fixed ends of the auxiliary elastic strap when being not stressed and can be stretched to exceed the corresponding strap between the two fixed ends of the auxiliary elastic strap when being stressed.

Preferably, the elastic auxiliary straps are arranged on the inner sides of the straps respectively.

Furthermore, massage pads with convex massage nails are arranged on the inner sides, in contact with the human shoulders, on the upper parts of the straps respectively and are made of an elastic high-density EVA material.

The protruding height of the massage nails of each massage pad is 2.5 cm.

The elastic hollow breathable massaging burden-reducing backpack, characterized in that a quadrilateral groove corresponding to the human spine is formed in the middle part of the front surface of the backpack and is covered by a layer of breathable net to play a role in ventilation and protect the spine.

The groove is opened at the upper end and/or the lower end with the heat dissipation effect realized.

The depth of the groove is 2.5 cm.

The upper end or the lower end of the groove is opened, the corresponding bottom edge or the upper edge is parallel to the bottom edge of the backpack, and the two vertical edges are symmetrically inward concave arcs.

An elastic hollow breathable massaging burden-reducing backpack is characterized in that two flexible straps are arranged on the front surface of the backpack in a bilateral symmetrical manner. The upper end of each strap is connected to the upper part of the front of the backpack with an elastic rope, and the lower end of each strap can penetrate through a strap buckle arranged at the lower part of the front surface of the backpack and then is fixed; each strap has an elastic auxiliary strap, two ends of which are fixed on each strap; each elastic auxiliary strap is shorter than the corresponding strap between the two fixed ends of the elastic auxiliary strap when not stressed and can be stretched to exceed the corresponding strap between the two fixed ends of the elastic auxiliary back belt when being stressed. Massage pads are arranged on the inner sides, in contact with human shoulders, on the upper parts of the straps respectively and are made of an elastic high-density EVA material;

a quadrilateral groove corresponding to the human spine is formed in the middle part of the front surface of the backpack and is opened at the upper end and the lower end, and the two vertical edges of the groove are symmetrically inward concave arcs.

The elastic hollow breathable massaging burden-reducing backpack has the beneficial effects that: the falling impact force may be slowed down through the elastic ropes at the upper end of the shoulder straps and the elastic auxiliary straps on the two sides of the back, friction on the human shoulders may be reduced through the massage pads, the hollow design of the groove in the middle part of the front surface of the backpack plays the roles of ventilation and spine protection, and gravity cannot directly press the spine when being on the backpack, so that the spine is protected, and the heat provided from the human back can be further guided outsides and dissipated.

### BRIEF DESCRIPTION OF THE DRAWINGS

FIG. 1 is one of the front schematic views of a backpack of Embodiment 1.

FIG. 2 is a second front schematic view of the backpack of Embodiment 1 (with straps secured by strap buckles respectively).

FIG. 3 is a schematic view of a strap and an auxiliary elastic strap of Embodiment 1 of FIG. 2.

FIG. 4 is a front schematic view of a backpack of Embodiment 2;

Numbers in the drawings are as follows:
1. backpack;
2. strap;
3. elastic rope;
4. strap buckle;
5. auxiliary strap;
6. massage pad;
7. groove.

### DETAILED DESCRIPTION OF THE INVENTION

The present invention is described below in detail in combination with the specific embodiments in the attached drawings.

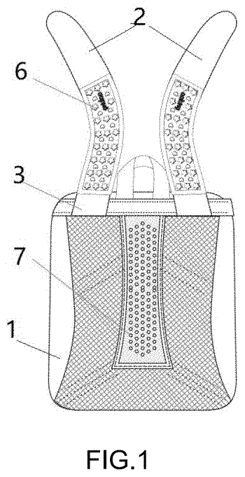

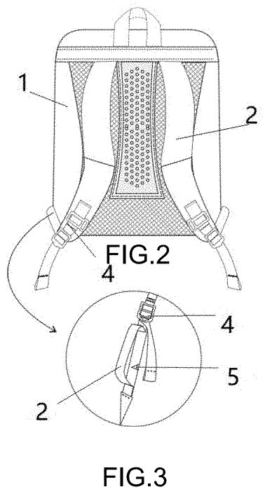

FIG. 1, FIG. 2, and FIG. 3 show Embodiment 1 of the elastic hollow breathable massaging burden-reducing backpack. From the drawings, two flexible straps 2 are arranged on the front surface of the backpack 1 in a bilateral symmetrical manner totally, the upper end of each strap is connected to the upper part of the front surface of the backpack through a rubber band 3, and the lower end of each strap penetrates through the corresponding strap buckle 4 arranged at the lower part of the front surface of the backpack 1 and then is fixed.

Referring to FIG. 3, each strap 2 is provided with an elastic auxiliary strap 5, the two ends of which are fixed to the corresponding strap at a certain interval, so that each auxiliary elastic strap is shorter than the corresponding strap between the two fixed ends of each auxiliary elastic strap when not being stressed and can be stretched to exceed the corresponding strap between the two fixed ends of the auxiliary elastic strap when being stressed. The auxiliary elastic straps 5 are arranged on the inner sides of the straps 2 respectively.

Massage pads 6 with convex massage nails are arranged on the inner sides, in contact with human shoulders, on the upper parts of the straps 2 respectively and are made of an elastic high-density EVA material, and the protruding height of each massage nail of each massage pad is 2.5 cm.

Referring to FIG. 1 and FIG. 2, a quadrangular groove 7 is formed in the middle part of the front surface of the backpack 1, with the effect of protecting the spine realized. An opening formed in the upper end of the groove 7 communicates with the atmosphere and is covered by a layer of a ventilation net, so that the heat dissipation effect is exerted; and the groove has a depth of 2.5 cm. The bottom edge of the groove is parallel to the bottom edge of the backpack, and the two vertical edges are symmetrically inward concave arcs.

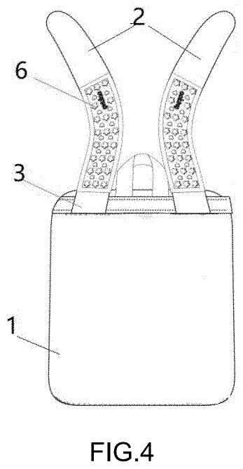

Embodiment 2 shown in FIG. 4 differs from Embodiment 1 described above only in that there is no groove in the middle part of the front surface of the backpack 1.

What is claimed is:

1. An elastic hollow breathable massaging burden-reducing backpack, wherein two flexible straps are arranged on the front surface of the backpack in a bilateral symmetry manner, the upper end of each strap is connected to the upper part of the front surface of the backpack through an elastic rope, and the lower end of each strap can penetrate through a strap buckle arranged on the lower part of the front surface of the backpack and then is fixed.

2. The elastic hollow breathable massaging burden-reducing backpack according to claim 1, wherein each strap is provided with an elastic auxiliary strap, the two ends of each auxiliary elastic strap are fixed on the corresponding strap at a certain interval, and each elastic auxiliary strap is shorter than the corresponding strap between the two fixed ends of each elastic auxiliary strap when not being stressed and can be stretched to exceed the corresponding strap between the two fixed ends of each elastic auxiliary back strap when being stressed.

3. The elastic hollow breathable massaging burden-reducing backpack according to claim 2, wherein the elastic auxiliary straps are arranged on the inner sides of the corresponding straps.

4. The elastic hollow breathable massaging burden-reducing backpack according to claim 1, wherein massage pads with convex massage nails are arranged on the inner side, in contact with human shoulders, on the upper parts of the straps respectively and are made of an elastic high-density EVA material.

5. The elastic hollow breathable massaging burden-reducing backpack according to claim 4, wherein a protruding height of each massage nail of each massage pad is 2.5 cm.

6. The elastic hollow breathable massaging burden-reducing backpack, wherein a quadrilateral groove, corresponding to a human spine, is formed in the middle part of the front surface of the backpack and is covered by a layer of breathable net.

7. The elastic hollow breathable massaging burden-reducing backpack according to claim 6, wherein the groove is opened at the upper end and/or the lower end.

8. The elastic hollow breathable massaging burden-reducing backpack according to claim 7, wherein the groove has a depth of 2.5 cm.

9. The elastic hollow breathable massaging burden-reducing backpack according to claim 8, wherein two vertical edges of the groove are symmetrically inward concave arcs.

10. An elastic hollow breathable massaging burden-reducing backpack, wherein two flexible straps are arranged on the front surface of the backpack in a bilateral symmetry manner, the upper end of each strap is connected to the upper part of the front surface of the backpack through an elastic rope, and the lower end of each strap can penetrate through a strap buckle arranged at the lower part of the front surface of the backpack and then is fixed; each strap is provided with an elastic auxiliary strap, and two ends of each elastic auxiliary strap are fixed on the corresponding strap; each elastic auxiliary strap is shorter than the corresponding strap between the two fixed ends of each elastic auxiliary strap when not being stressed and can be stretched exceed the corresponding strap between the two fixed ends of each elastic auxiliary back strap when being stressed; massage pads are arranged on the inner sides, in contact with human shoulders, on the upper parts of the straps respectively and are made of an elastic high-density EVA material;
and a quadrilateral groove, corresponding to the human spine, is formed in the middle part of the front surface of the backpack and is opened at the upper end and/or the lower end, and two vertical edges of the groove are symmetrically inward concave arcs.
